(19) United States
(12) Patent Application Publication
(10) Pub. No.: US 2025/0166093 A1
(43) Pub. Date: May 22, 2025

(54) Energy Management Method Based on Multi-Agent Reinforcement Learning in Energy-Constrained Environments

(71) Applicant: Anhui University, Hefei (CN)

(72) Inventors: Ning ZHANG, Hefei (CN); Lingxiao YANG, Hefei (CN); Changyin SUN, Hefei (CN); Chaoxu MU, Hefei (CN); Chenxu SHI, Hefei (CN); Xiang CAO, Hefei (CN); Yanxu SU, Hefei (CN); Hongbing XIA, Hefei (CN); Hejia GAO, Hefei (CN)

(73) Assignee: Anhui University, Hefei (CN)

(21) Appl. No.: 18/754,120

(22) Filed: Jun. 25, 2024

(30) Foreign Application Priority Data
Nov. 21, 2023 (CN) 2023115787964

(51) Int. Cl. G06Q 50/06; G06Q 10/04

(52) U.S. Cl. CPC G06Q 50/06; G06Q 10/04

(57) ABSTRACT

The present invention relates to an energy flow scheduling method based on multi-agent reinforcement learning, and the method comprising: designing an energy flow transmission mode for clustered islands, so as to describe energy transmission processes in between the clustered islands; building an energy flow transmission model for the clustered islands based on the energy flow transmission mode; establishing an energy system energy management model for the clustered islands; and realizing energy flow scheduling for the clustered islands based on multi-agent reinforcement learning methods and solving an energy management strategy. In the present invention, based on multi-agent reinforcement learning methods, in consideration of location characteristics of the clustered islands, reserves of renewable resources and mobile energy storage of electric vessels, self-adaption to changes in load requirements of islands with human settlements is satisfied.

### INCORPORATION BY REFERENCE

This application claims the benefit of priority from China Patent Application No. 2023115787964 filed on Nov. 21, 2023, the contents of which are hereby incorporated by reference in their entirety.

### TECHNICAL FIELD

The present invention relates to the technical field of optimized decision of energy systems, specifically an energy flow scheduling method for pelagic clustered islands based on multi-agent reinforcement learning.

### BACKGROUND TECHNOLOGY

In China there are many islands, exploitation and development of offshore islands is relatively full, however, development and exploitation of pelagic islands is relatively insufficient. As important fulcrums and platforms for guaranteeing national coast defense and marine benefits, the pelagic islands usually require highly reliable power supplies; however, currently power supplies for most of pelagic islands rely on independent operations of diesel generators. Restrictions of such power supply are outstanding and high operation expenses and carbon emission pollution due to diesel generators will result in global environmental problems. Pelagic islands are rich in renewable energies such as wind, light, sea current, wave and tidal energies, which are characterized in being abundant, widely distributed, clean and renewable. Therefore, a new power supply way is provided by generating power with the renewable energies to supply the pelagic islands, which also provides a potential method for addressing shortage of conventional fossil fuels and high energy cost. However, due to strong uncertainties of unique spatial distribution and environments of pelagic islands, there exist a lot of limitations in energy flow scheduling of energy systems in pelagic clustered islands: 1) due to existence of natural geological isolations in between the pelagic islands, sources and loads are converse in pelagic islands, consequently energy flow transmission in between the pelagic clustered islands is limited. 2) in view of optimized control of energy systems, the conventional optimized control methods tend to be restricted when being used in conditions with no environment models or unknown global optimum.

### SUMMARY OF INVENTION

In view of deficiencies of the prior art, the present invention provides an energy flow scheduling method for pelagic clustered islands based on reinforcement learning of multi-agent systems, with this method, the problem of limited energy flow transmission in between islands due to converse distribution of sources and loads in pelagic islands is addressed, further, by solving energy flow scheduling and energy management strategies by multi-agent reinforcement learning methods, restrictions of conventional optimized control methods when being used in conditions of no environment model or unknown global optimum is addressed. With the present method, an ecologically friendly pelagic clustered island energy system is built based on abundant renewable resources and mobile energy storage of at least one electric vessel in resource rich islands to guarantee energy demands of islands with human settlements. Energy flow scheduling can be realized under conditions of restricted energy flow transmission via a model of an energy management system for clustered islands, and multi-agent reinforcement learning can be used to solve the problem of energy management in between clustered islands, so as to realize energy sustenance in the clustered islands, promote sustainable development of pelagic clustered islands, and this provides a new insight for implementation and application of the energy Internet idea.

To solve the foregoing technical problems, the present invention proposes the following technical solutions: an energy flow scheduling method for pelagic clustered islands based on multi-agent reinforcement learning, comprising:
Step 1: designing an energy flow transmission mode for clustered islands, wherein the mode is configured to describe energy flow transmission processes in between the clustered islands;
Step 2: building an energy flow transmission model for the clustered islands based on the energy flow transmission mode for the clustered islands;
Step 3: building an energy management model for an energy system of the clustered islands according to the energy flow transmission model for the clustered islands; and
Step 4: realizing energy flow scheduling for the clustered islands by multi-agent reinforcement learning methods, and solving an energy management strategy.

Further, in the step 1, designing the energy flow transmission mode for clustered islands comprises specifically the following steps:
Step 1-1: forming spatial distribution for at least one island with human settlements and a plurality of resource-rich islands according to unique geological positions of pelagic clustered islands;
Step 1-2: building power generators including at least one wind power generation facility and at least one photovoltaic power generation facility for the resource-rich islands according to features of islands having rich renewable resources, and building a model for a renewable energy power generation facility for the clustered islands, wherein the model comprises:

$${P}_{w} = \frac{1}{2} {ρ}_{air} {A}_{w} {C}_{p} {v}^{3} ;$$

$${P}_{s} = η {A}_{s} G ;$$

In the formula, P_{w} and Pₛ stand for output power of the at least one wind power generation facility and the at least one photovoltaic power generation facility, Pₐᵢᵣ stands for air density, Aw stands for an efficient area of wind passing at least one wind turbine, Cₚ stands for a power coefficient of the at least one wind turbine of the at least one wind power generation facility, v stands for wind velocity, η stands for a power conversion efficiency of the at least one photovoltaic power generation facility, A, stands for an area of at least one solar cell, and G stands for solar radiation strength;

Step 1-3: building an energy flow scheduling frame including at least one electric vessel based on natural geological isolation between the at least one island with the human settlements and the resource-rich islands and building an electric vessel operation model, wherein the electric vessel operation model comprises:

$${P}_{EV}^{sail} = {F}_{EV} {V}_{EV} cos θ ;$$

In the formula, Pₛₐᵢₗ^{EV} stands for electric vessel navigation power, F_{EV} stands for thrust of the at least one electric vessel, V^{E}V stands for a navigation velocity of the at least one electric vessel, θ stands for an included angle between the thrust and the navigation velocity of the at least one electric vessel;
Wherein, the thrust of the at least one electric vessel F_{EV}, an air friction Fₐᵢᵣ and ocean current force F^{cur} satisfy:

$${F}_{air}^{2} + {F}_{cur}^{2} - {F}_{EV}^{2} = 2 {F}_{air} {F}_{cur} cos γ ;$$

In the formula, γ is an included angle between the air friction and the ocean current force; models of the air friction Fₐᵢᵣ and the ocean current force F_{cur} are respectively:

$${F}_{air} = \frac{9.807 {ρ}_{air} {C}_{w} {K}_{α} {A}_{ev} {V}_{rs}}{2} ;$$

$$\{ \begin{matrix}{F}_{xcur} = \frac{{ρ}_{water} {MV}_{crs}^{2} {C}_{xcur , β}}{2} \\ {F}_{ycur} = \frac{{ρ}_{water} {MV}_{crs}^{2} {C}_{ycur , β}}{2} \\ {F}_{cur} = \sqrt{{F}_{xcur}^{2} + {F}_{ycur}^{2}}\end{matrix} ;$$

In the formula, C_{w} stands for a wind resistance coefficient where a wind angle is 0°, C_{xcur,β} and C_{ycur,β} stand for ocean current force coefficients where a relative angle of current is β, Kₐ stands for a wind influencing coefficient where the relative angle of current is a, Aₑᵥ stands for a projected area of a portion of the at least one electric vessel above a ship waterline on a cross section, Vᵣₛ stands for a relative wind speed of the at least one electric vessel, V_{crs} stands for a relative ocean current speed, M is a product of a length of the waterline and a draught, the length of the waterline stands for a projected length of the at least one electric vessel on a water surface, and the draught stands a depth of the at least one electric vessel in the water, β_{water} stands for seawater density, and F_{xcur} and F_{ycur} stand for sea current forces that the at least one electric vessel are subjected to on a horizontal direction and a vertical direction.

Further, building the energy flow transmission model for the clustered islands in the step 2, specifically comprises the following steps:

Step 2-1: conducting pre-dispatch for the energy flow scheduling system for the clustered islands, predicting and scheduling power demands of m island(s) with the human settlements and power supply of n resource-rich islands, and the resource-rich islands and the islands with the human settlements satisfy constraints:

$${\sum }_{i = 1}^{n} {E}_{i , t} \leq {E}_{j , t} j ∈ [ 1 , m ] , t ∈ T ;$$

In the formula, E_{i,t} stands for power supplied to an ith resource-rich island at a time t, E_{j,t} stands for a power demand for a jth island with human settlements at the time t, and T stands for total time duration;

Step 2-2: establishing an energy flow transmission mechanism according to pre-dispatch of the energy flow scheduling system for the pelagic islands:

$$\{ \begin{matrix}{A}_{i , t} & = {N}_{ij , t} \\ {S}_{j , t} & = {\sum }_{i = 1}^{n} {N}_{ij , t}\end{matrix} i ∈ [ 1 , n ] , j ∈ [ 1 , m ] , t ∈ T$$

Wherein, N_{ij,t} stands for a number of at least one electric vessel sent to the jth island with human settlements from the ith resource-rich island at the time t, A_{i,t} stands for a number of at least one electric vessel sent from the ith resource-rich island at the time t, S_{j,t} stands for a number of at least one electric vessel received by the jth island with human settlements at the time t, specifically, S_{j,t} is defined as the number of at least one electric vessel dispatched at the jth island with human settlements at the time t, which is a summation of the number of at least one electric vessel from the resource-rich island 1 until the resource-rich island n at the time t to the jth island with human settlements;

$$\{ \begin{matrix}{S}_{1 , t} & = {N}_{11 , t} + {N}_{21 , t} + … + {N}_{n 1 , t} \\ {S}_{2 , t} & = {N}_{12 , t} + {N}_{22 , t} + … + {N}_{n 2 , t} \\ ⋮ & \\ {S}_{m , t} & = {N}_{1 m , t} + {N}_{2 m , t} + … + {N}_{nm , t}\end{matrix}$$

Step 2-3: as a mobile energy storage tool, the at least one electric vessel charge and discharge in different times in the resource-rich islands and the islands with human settlements to realize spatio-temporal transference of the energy flow in between islands, and an electric vessel charging and discharging model is defined as:

$${E}_{EV , t} = \{ \begin{matrix}{E}_{EV , t - 1} + {P}_{EV , t - 1} ζΔ t & {P}_{EV , t - 1} < 0 \\ {E}_{EV , t - 1} - \frac{{P}_{EV , t - 1}}{ζ} Δ t & {P}_{EV , t - 1} \geq 0\end{matrix}$$

In the equation, E_{EV,t} and E_{EV,t-1} stand for energy storage amounts of the at least one electric vessel at the time t and a time t−1, P_{EV,t-1} is a real-time power during charging and/or discharging of the at least one electric vessel at the time t−1, ξ stands for charge-discharge efficiency, and Δt stands for a temporal interval;

Further, to evaluate whether the at least one electric vessel charge or discharge fully is described by a state of charge SOC_{EV}, SOC_{EV}=1 stands for fully charged, SOC_{EV}=0 stands for fully discharged, and definitions of the same are:

$$S O {C}_{EV} = \frac{{E}_{sur}}{{E}_{total}} ;$$

$$S O {C}_{EV , min} \leq S O {C}_{EV} \leq S O {C}_{EV , max} ;$$

In the formula, Eₛᵤᵣ stands for remaining energy storage in the at least one electric vessel, Eₜₒₜₐₗ stands for total energy storage in the at least one electric vessel, and SOC_{EV,max} and SOC_{EV,min} stand for maximum and minimum statements of charge.

Further, in the step 2-2, depending on pre-dispatching of the system and capacity Cap_{EV} of the at least one electric vessel, the system will decide whether each of the resource-rich islands shall send an electric vessel to the islands with human settlements and a number of the at least one electric vessel, and after energy scheduling, each of the islands with human settlements shall satisfy:

$${S}_{j , t} * {Cap}_{EV} \leq {E}_{j , t} ;$$

Further, in the step 3 establishing the energy management model for the energy system for the clustered islands, specifically, comprising:

Step 3-1: designing an energy management object function for the resource-rich islands, comprising two parts: expenses for transporting energies with the at least one electric vessel and wind and light usage expenses of the resource-rich islands, aiming at satisfying loads of the islands with human settlements and reducing transportation expenses of the energy flow and waste of the renewable energies, and the object function Fᵣ is expressed as following:

$${F}_{r} = {\sum }_{t ∈ E} {\sum }_{i = 1}^{n} {\sum }_{j = 1}^{m} {ξ}_{ij} {d}_{ij} {N}_{ij , t} {E}_{EV , t} + {\sum }_{t ∈ E} {\sum }_{i = 1}^{n} ψ ( {E}_{wind , i , t} + {E}_{pv , i , t} )$$

Wherein, dᵢⱼ stands for a distance in between the ith resource-rich island and the jth island with human settlements, E_{wind,i,t} is a wind consumption amount at the ith resource-rich island at the time t, E_{pv,i,t} is a light consumption amount of the ith resource-rich island at the time t, ξᵢⱼ is a distance coefficient in between the ith resource-rich island and the jth island with human settlements, and ψ stand for a wind and light consumption penalty factor;

Step 3-2: designing an energy management result function for the islands with human settlements, comprising: cancelling expenses for controllable loads if necessary in order to ensure stability and reliability of operations of the power system of the clustered islands, and the result function Fₕ can be expressed as:

$${F}_{h} = {\sum }_{t ∈ T} {\sum }_{j = 1}^{m} λ {E}_{cut , j , t} ;$$

Wherein E_{cut,j,t} stands for the cancelled controllable loads in the jth island with human settlements at the time t and λ is a load cancelling penalty factor.

Further, in the step 4, realizing energy flow scheduling for the clustered islands by multi-agent reinforcement learning method and solving the energy management strategy comprising specifically:
Step 4-1: establishing self-defined pelagic clustered island environments for multi-agent systems based on third-party libraries such as PettingZoo and extensions, and overcoming restrictions of standard Gym library in multi-agent support;
Specifically, in the step 4-1, establishing the self-defined multi-agent pelagic clustered island environments comprising specifically the following steps:
Step 4-1-1: defining self-defined environment class, realizing necessary methods, and the methods define interaction logics for the pelagic clustered island environment;
Step 4-1-2: in a custom pelagic clustered island environment class, defining a state space S, an action space A and a reward mechanism R;
Step 4-1-3: interacting the created pelagic clustered island environment with the intelligent agent, testing and commissioning correctness and stability of the environment.
Step 4-2: designing a deep reinforcement learning method based on counterfactual baseline, for energy flow scheduling for the clustered islands and solving the energy management strategy.

Specifically, the step 4-2 specifically comprises the following steps:
Step 4-2-1: building a centralized training and decentralized execution deep reinforcement learning algorithm structure based on Actor-Critic frame, wherein an architecture thereof comprises a centralized Critic network and an Actor network with the same number of actors as the intelligent agents;
Step 4-2-2: calculating an action strategy for each of the intelligent agents based on observation information of each of the island intelligent agents and using the Actor network;
Step 4-2-3: calculating a dominant function based on the counterfactual baseline and using the Critic network, and reverting the corresponding result to the corresponding Actor network, so as to address the credit assignment problem;
Step 4-2-4: using actions u^{-a} of other intelligent agents as a part of an input of the Critic network to calculate the counterfactual baseline more efficiently, during outputting, reserving only counterfactual Q values of actions of a single intelligent agent a, and efficient Critic network input and output are expressed as:

$$( {u}_{t}^{- a} , {s}_{t} , {o}_{t}^{a} , a , {u}_{t - 1} ) \to \{ Q ( {u}^{a} = 1 , {u}_{t}^{- a} , … ) , … , Q ( {u}^{a} = \vert U \vert , {u}_{t}^{- a} , … ) \} {\to }^{( {u}_{t}^{a} {π}_{t}^{a} )} {A}_{t}^{a}$$

Wherein Q represents an action value function of the intelligent agent, O^{a} stands for observation of the intelligent agent a, a is a serial number of the intelligent agent, after obtaining the counterfactual Q value of the action of the intelligent agent a, obtaining the dominant function Aₜ^{a} of the intelligent agent at the time t of the action according to the strategy distribution πₜ^{a} obtained via the Actor network and the action uₜ^{a} at the current moment.

Further, a method to calculate the dominant function in the step 4-2-3 is: estimating Q value of united action u in condition of a global state of the system using the centralized Critic network in the step 4-2-1, thereafter, comparing the Q value of the current action u^{a} with the counterfactual baseline of marginalized u and in the meanwhile, maintaining actions of the other intelligent agents unchanged, the dominant function A^{a} (s,u) is defined as following:

$${A}^{a} ( s , u ) = Q ( s , u ) - {\sum }_{{u}^{′ a}} {π}^{a} ( {u}^{′ a} \vert {τ}^{a} ) Q ( s , ( {u}^{- a} , {u}^{′ a} ) )$$

In the formula, u′^{a} stands for action after marginalization of the intelligent agent a, U^{-a} stands for united actions of all other intelligent agents without the intelligent body a, τ^{a} stands for a trace sequence of the intelligent agent a, π^{a}(u′^{a}|τ^{a}) stands, and for an action selection strategy of the intelligent agent a in the trace sequence τ^{a}, and Q(s,(u^{-a} u′^{a})) stands for the Q value when replacing the action of the intelligent agent a with the marginalized action.

Based on the foregoing technical solutions, the present invention provides an energy flow scheduling method based on multi-agent reinforcement learning, and has at least the following beneficial effects:

In the present invention an operation model and a charge-discharge model for at least one electric vessel are built, taking into consideration of spatial location characteristics of clustered islands, reserves of renewable energies and mobile energy storage of the at least one electric vessel, difficulty in direct energy flow transportation natural geological isolation of in between the clustered islands can be overcome, so as to satisfy self-adaption to changes of loads of islands with human settlements; with the energy management system model for the clustered islands, an energy management object function for the clustered islands is designed, while satisfying loads and demands of the islands with human settlements and promising operation stability and reliability of the power system, by optimized scheduling of the energy system of the islands, the target is to minimize the object function, that is to reduce expenses for energy flow transportation, waste of renewable resources and removing expenses of controllable loads; with the multi-agent reinforcement learning method, energy flow scheduling in conditions of restricted energy flow transmission is realized, in this way, the restricted energy flow transmission in between the clustered islands due to inverted distribution of sources and loads is addressed; compared with other algorithms, the method proposed in the present invention has integrated baseline functions on the basis of centralized training and decentralized execution, and usage of the baseline function can improve efficiency and stability of the algorithm and improve reliability and stability of the power system in the clustered islands, the problem of restrictions encountered when using conventional optimization control methods in dealing with problems with no environment model or unknown global optimization is solved, sustainable development of the pelagic clustered islands can be promoted and a new thought is provided for implementation and application of the energy Internet idea.

### BRIEF DESCRIPTION OF DRAWINGS

The drawings given here are employed to provide a further understanding of the present invention, and construe a part of the present invention, the explanatory embodiments and explanations thereof are only used to explain the present invention and do not form any improper limitations on the present invention. In the drawings:

FIG. 1 is an energy flow scheduling model according to an embodiment of the present invention; and

FIG. 2 is a flowchart diagram showing an energy flow scheduling method for pelagic clustered islands based on multi-agent reinforcement learning according to an embodiment of the present invention.

### EMBODIMENTS

To make the purposes, features and advantages of the present invention more obvious, hereinafter a further detailed description will be given to the present invention in conjunction with the drawings and the embodiments. In this way, how the present invention applies the technical solutions to address the technical problems and achieves the technical effects can be fully understood and implemented.

Those of ordinary skill in the art can appreciate that, all or some steps in the method embodiments of the present invention can be completed by having a program instructing the corresponding hardware, therefore, the present invention can be in the form of absolute hardware embodiments, absolute software embodiments or combined software and hardware embodiments. Further, the present invention can be implemented in the form of a computer program product executed on one or more computer readable storage media (including but not limited to magnetic disc memory, CN-ROM and optical memory etc.) comprising computer readable program codes.

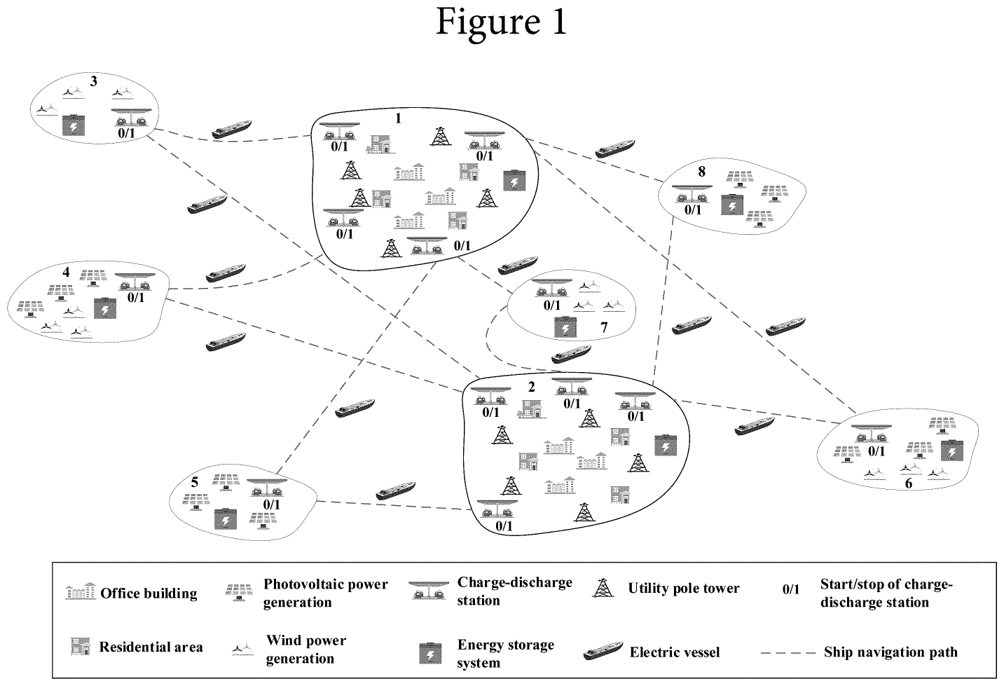

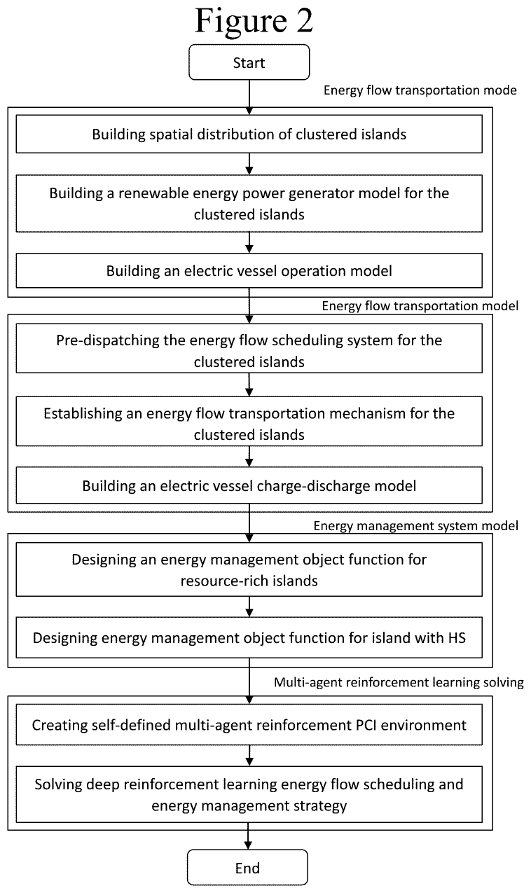

With reference to FIGS. 1-2, an embodiment of the present invention is given, in the present embodiment, in view of location characteristics of the clustered islands, reserves of renewable energies and mobile energy storage of at least one electric vessel energy demands of islands with human settlements are guaranteed. With the energy management system model for the clustered islands, energy flow scheduling in restricted energy flow transmission environments can be realized, and multi-agent reinforcement learning is used to address the problem of energy management in between the clustered islands, so as to realize self-sufficiency of energies in the pelagic clustered islands, promote sustainable development of the clustered islands, and provide a new insight for implementation and application of the energy Internet idea.

In the present invention, a clustered island energy system based on an energy flow scheduling method for pelagic clustered islands based on multi-agent reinforcement learning is proposed, as shown in FIG. 1, islands no. 1 and 2 are islands with human settlements, islands no. 3, 4, 5, 6, 7, and 8 are resource-rich islands. In each of the islands, an energy storage system with a power capacity of 10 MW/h and a charge-discharge island for charging and discharging at least one electric vessel are provided. The photovoltaic power generation system equipped for the resource-rich islands is 500 kW, and a wind power generation system is 800 kW. The power capacity of the at least one electric vessel is 800 kW/h. Further, utility pole towers are provided in the two islands with human settlements, although disperse transmission of energy packs is realized by the at least one electric vessel in between the resource-rich islands and the islands with human settlements, continuous and real-time energy transmission in the islands with human settlements can be realized via the utility pole towers.

With the foregoing energy flow scheduling method for pelagic clustered islands based on multi-agent reinforcement learning, the entire flow process is as shown in FIG. 2, specifically comprising the following steps:
Step 1: designing an energy flow transmission mode for clustered islands, wherein the mode is configured to describe energy transmission processes in between the clustered islands;
Step 1-1: forming spatial distribution for islands with human settlements and resource-rich islands according to unique geological positions of the pelagic clustered islands;
Step 1-2: building power generation devices including wind power generation equipment and photovoltaic power generation equipment for the resource-rich islands according to features of abundant renewable energies around the islands, and building a renewable energy power generation equipment model for the clustered islands, and the model comprises:

$${P}_{w} = \frac{1}{2} {ρ}_{air} {A}_{w} {C}_{p} {v}^{3} ;$$

$${P}_{s} = η {A}_{s} G ;$$

In the formula, P_{w} and Pds stand for output power of the wind power generator and the photovoltaic power generator, Pₐᵢᵣ stands for air density, A_{w} is an efficient area of wind passing a wind turbine, Cₚ stands for a power coefficient of the wind turbine of the wind power generator, v stands for wind velocity, η stands for conversion efficiency of energy generated by the photovoltaic power generator, Aₛ stands for an area of the photovoltaic cell, and G stands for solar irradiation strength;

Step 1-3: building an energy flow scheduling frame containing at least one electric vessel according to natural geological isolation characteristics between islands with human settlements and resource-rich islands, and building a electric vessel operation model, wherein the model is:

$${P}_{EV}^{sail} = {F}_{EV} {V}_{EV} cos θ ;$$

Wherein P_{EV}^{sail} stands for navigation power of at least one electric vessel, F_{EV} stands for thrust of the at least one electric vessel, V_{EV} stands for navigation velocity of the at least one electric vessel, and θ stands for an included angle in between the thrust of the at least one electric vessel and the navigation velocity;

Wherein F_{EV} the thrust of the at least one electric vessel F_{EV}, the air friction Fₐᵢᵣ and the ocean current force F_{cur} satisfy:

$${F}_{air}^{2} + {F}_{cur}^{2} - {F}_{EV}^{2} = 2 {F}_{air} {F}_{cur} cos γ ;$$

Wherein, γ stands for an included angle between the air friction and the ocean current force; and models for the air friction Fₐᵢᵣ and the ocean current force F_{cur} are respectively:

$${F}_{air} = \frac{9 \text{.807} {ρ}_{air} {C}_{w} {K}_{a} {A}_{ev} {V}_{rs}}{2} ;$$

$$\{ \begin{matrix}{F}_{xcur} & = \frac{{ρ}_{water} {MV}_{crs}^{2} {C}_{xcur β}}{2} \\ {F}_{ycur} & = \frac{{ρ}_{water} {MV}_{crs}^{2} {C}_{ycur β}}{2} \\ {F}_{cur} & = \sqrt{{F}_{xcur}^{2} + {F}_{ycur}^{2}}\end{matrix} ;$$

Wherein C_{w} stands for an air friction coefficient where a wind angle is 0°, C_{xcur,β} and C_{ycur,β} stand for ocean current force coefficients where a relative flow angle is β,Kₐ is a wind influencing factor where a relative wind angle is a, Aₑᵥ is a projected area of a portion of the at least one electric vessel above the waterline on a cross section, Vᵣₛ stands for a relative wind velocity of the at least one electric vessel, V_{crs} stands for a relative ocean velocity, M stands for a product of a length of the waterline and a draught, the length of the waterline stands for a projected length of the at least one electric vessel on a water surface, the draught means an immergence depth of the at least one electric vessel, ρ_{water} is a seawater density, and F_{xcur} and F_{ycur} stand for the ocean current forces those the at least one electric vessel are subjected to horizontally and vertically.

In the present embodiment, an operation equation for power generators and power transporter is given according to power generation methods and transportation methods for the clustered islands, based on mobile energy storage characteristics of the at least one electric vessel and abundant renewable energies in the resource-rich islands, energy need of the islands with human settlements is satisfied, an energy flow system for pelagic clustered island that is ecologically friendly is built to provide a path for addressing restricted energy flow transmission for the clustered islands due to inverted distribution of sources and loads for the pelagic clustered islands.

Further, building the energy flow transmission model for the clustered islands in the step 2, comprising specifically the following steps:
Step 2-1: pre-dispatching the energy flow scheduling system for the clustered islands, predicting and planning power demands of m islands with human settlements and n resource-rich islands, and the resource-rich islands and the islands with human settlements satisfy the following constraint:

$${\sum }_{i = 1}^{n} {E}_{i , t} \leq {E}_{j , t} j ∈ [ 1 , m ] , t ∈ T ;$$

Wherein E_{i,t} represents electric power supplied by the ith resource-rich island at a time t, E_{j,t} represents a power demand of a jth island with human settlements at the time t and T represents total time duration;
Step 2-2: establishing an energy flow transmission mechanism in between the clustered islands according to pre-dispatching of the energy flow scheduling system of the clustered islands:

$$\{ \begin{matrix}{A}_{i , t} & = {N}_{ij , t} \\ {S}_{j , t} & = {\sum }_{i = 1}^{n} {N}_{ij , t}\end{matrix} i ∈ [ 1 , n ] , j ∈ [ 1 , m ] , t ∈ T ;$$

Wherein Nij,t stands for a number of at least one electric vessel sent from the ith resource-rich island to the jth island with human settlements at the time t, A_{i,t} stands for a number of the at least one electric vessel sent from the ith resource-rich island at the time t, S_{j,t} is a number of the at least one electric vessel received at the jth island with human settlements at the time t, specifically, S_{j,t} is defined as following, that is, the number of at least one electric vessel appointed to the jth island with human settlements at the time t equals a sum of at least one electric vessel sent from the 1st resource-rich island to the nth resource-rich island at the time t.

$$\{ \begin{matrix}{S}_{1 , t} = {N}_{11 , t} + {N}_{21 , t} + … + {N}_{n 1 , t} \\ {S}_{2 , t} = {N}_{12 , t} + {N}_{22 , t} + … + {N}_{n2 , t} \\ ⋮ \\ {S}_{m , t} = {N}_{1 m , t} + {N}_{2 m , t} + … + {N}_{nm , t}\end{matrix}$$

Step 2-3: as a power storage tool, the at least one electric vessel charge and discharge in different times in the resource-rich islands and the islands with human settlements to complete temporal and spatial transference of energy flows in between the islands, and the electric vessel charge-discharge model is defined as:

$${E}_{EV , t} = \{ \begin{matrix}{E}_{EV , t - 1} + {P}_{EV , 1 - 1} ζ Δ t & {P}_{EV , t - 1} < 0 \\ {E}_{EV , t - 1} - \frac{{P}_{EV , 1 - 1} ζ}{ζ} Δ t & {P}_{EV , t - 1} \geq 0\end{matrix} ;$$

Wherein, E_{EV,t} and E_{EV,t-1} stand for energy storage amounts of the at least one electric vessel at the time t and a time t−1, P_{EV,t-1} is a real-time electric vessel charge-discharge power at the time t−1, ξ is a charge-discharge efficiency and Δt is a time interval;
Further, to evaluate whether the at least one electric vessel charge or discharge fully is described by a state of charge SOC_{EV}, wherein SOV_{EV} means fully charged, SOC_{EV}=0 means fully discharged, and definitions thereof are:

$${SOC}_{EV} = \frac{{E}_{sur}}{{E}_{total}} ;$$

$${SOC}_{EV , min} \leq {SOC}_{EV} \leq {SOC}_{EV , max} ;$$

Wherein Eₛᵤᵣ stands for residual energy storage in the at least one electric vessel, Eₜₒₜₐₗ stands for total energy storage in the at least one electric vessel, and SOC_{EV,max} and SOC_{EV,min} stand for a maximum and a minimum state of charge of the at least one electric vessel.

In the present embodiment, an energy flow transportation model for the clustered islands is built, and the model is to represent the energy flow transportation mechanism for the clustered islands and charge-discharge processes of the at least one electric vessel in the clustered islands, in this way, difficulty in direct energy flow transportation due to natural geological isolation in between the clustered islands is overcome, self-adaption to changes of loads of the islands with human settlements is promised, and a profound basis is built for energy flow scheduling for the pelagic clustered islands.

Step 3: establishing an energy management model for the energy system of the clustered islands according to the energy flow transportation model of the clustered islands;
Step 3-1: designing an energy management object function for the resource-rich islands, comprising two parts: expenses for energy transportation with the at least one electric vessel, and expenses for wind and light consumption of the resource-rich islands, and the object is to satisfy loads of the islands with human settlements and reduce expenses for energy transportation and waste of renewable energies, and the object function Fᵣ is expressed as following:

$${F}_{r} = {\sum }_{t ∈ T} {\sum }_{i = 1}^{n} {\sum }_{j = 1}^{m} {ξ}_{ij} {d}_{ij} {N}_{ij , t} {E}_{EV , t} + {\sum }_{t ∈ T} {\sum }_{i = 1}^{n} ψ ( {E}_{wind , i , t} + {E}_{pv , i , t} ) ;$$

In the equation, dᵢⱼ is a distance between an ith resource-rich island and a jth island with human settlements, E_{wind,i,t} is a wind consumption of the ith resource-rich island at a time t, E_{pv,i,t} is a light consumption of the ith resource-rich island at the time t, ξᵢⱼ is a distance coefficient between the ith resource-rich island and the jth island with human settlements, and ψ is a wind and light consumption penalty factor.

Specifically dᵢⱼ is defined as:

$${d}_{ij} = \{ \begin{matrix}{d}_{ji} = const & i \neq j \\ 0 & i = j\end{matrix} ;$$

A distance matrix that the at least one electric vessel may navigate:

$$D = [ {d}_{ij} ] = [ \begin{matrix}{d}_{11} & … & {d}_{1 m} \\ ⋮ & ⋱ & ⋮ \\ {d}_{n 1} & … & {d}_{nm}\end{matrix} ] ;$$

The wind and light consumption Eₛᵤᵣₚₗᵤₛ is calculated as following:

$${E}_{surplus} = {\sum }_{t ∈ T} {\sum }_{i = 1}^{n} ( {a}_{i} {P}_{w , t , i} {T}_{w , t , i} + {b}_{i , t} {P}_{s , t , i} {T}_{s , t , i} ) - {\sum }_{t ∈ T} {\sum }_{i = 1}^{n} {N}_{ij , t} {E}_{EV , t} j ∈ [ 1 , m ]$$

Wherein P_{w,t,i} and P_{s,t,i} represent output powers of the wind power generator and the photovoltaic power generator at the ith resource-rich island, T_{w,t,i} and T_{s,t,i} represent power generation time of the wind power generator and the photovoltaic power generator at the ith resource-rich island at the time t, and a_{i,t} and b_{i,t} are a number of working wind power generators and photovoltaic power generators in the i th resource-rich island at the time t.
Step 3-2: designing an energy management object function for the islands with human settlements, comprising: cancelling expenses for controllable loads if necessary, and the object is promise operation stability and reliability of the power system in the clustered islands, and the object function Fₕ is expressed as following:

$${F}_{h} = {\sum }_{t ∈ T} {\sum }_{i = 1}^{m} λ {E}_{cut , j , t} ;$$

Wherein E_{cut,j,t} represents the controllable loads cancelled at the jth island with human settlements at the time t and λ is a load cancelling penalty factor.

Specifically E_{cut,j,t} is calculated as following:

$${E}_{cut , j , t} = {\sum }_{t ∈ T} {E}_{j , t} - {\sum }_{t ∈ T} {\sum }_{i = 1}^{n} {N}_{ij} {E}_{EV , t} j ∈ [ 1 , m ] ;$$

In the present embodiment, the energy management model is built for the energy system of the clustered islands, the energy management object function is designed for the clustered islands, while promising operation stability and reliability of the power system in the clustered islands and satisfying loads of the islands with human settlements, by optimized scheduling of the energy system for the clustered islands, the target is minimize the object function, that is, reduce the expenses for energy flow transportation, waste of the renewable energies and cancelling expenses for controllable loads, so as to realize energy flow scheduling based on limited energy flow transportation environments and the problem of restricted energy flow transportation due to inverted distribution of loads and sources in the pelagic clustered islands is solved, self-sufficiency of energies in the pelagic clustered islands is realized, sustainable development of the clustered islands is promoted and a new thought is provided for implementation and application of the energy Internet idea.

Step 4: realizing energy flow scheduling for the clustered islands by multi-agent reinforcement learning, and solving the energy management strategy.

Step 4-1: creating a self-defined multi-agent pelagic clustered island environment based on third-party libraries and extensions such as PettingZoo, overcoming restrictions of a standard Gym library in multi-agent support, wherein PettingZoo and Gym are open source reinforcement learning environment libraries, providing standardized application programming interfaces and a plenty of preset environments, so as to enable the researchers and developers to build, test and compare learning algorithms of intelligent agents.

Step 4-1-1: defining self-defined environment class, realizing necessary methods, and the methods define interaction logics of the pelagic clustered island environment.

Step 4-1-2: defining state space S, action space A and a reward mechanism R for each of the intelligent agents in the self-defined pelagic clustered island environment class and according to the energy flow scheduling model for the pelagic clustered islands.

The state space S is set as following:

$$S = \{ {P}_{E , i , t}^{wind} , {P}_{E , i , t}^{pv} , {P}_{E , j , t}^{load} {Cap}_{EV} \} ;$$

Wherein, P_{E,i,t}^{wind} and P_{E,i,t}^{pv} stand for electric energy E output that the resource-rich island i obtained from the wind and light renewable energies at the time t and P_{E,j,t}^{load} is a load demand of the island with human settlements J for electric energy E.

The action space A is set as following:

$$A = \{ {υ}_{ij , t} , {N}_{dis , i , t}^{EV} , {N}_{rec , j , t}^{EV} \} ;$$

Wherein N_{dis,i,t}^{EV} stands for a number of the at least one electric vessel EV of the resource-rich island i at the time i, N_{rec,j,t}^{EV} is a number of the at least one electric vessel EV that the island with human settlements j received at the time t, and v_{ij,t} is a coefficient for judging whether the ith resource-rich island sends electric to the jth island with human settlements.

The reward mechanism R is configured as following:

$$R = - ( {oF}_{r} + ι {F}_{h} ) ;$$

Wherein o and t are demand adjustment parameters in the algorithm.

Step 4-1-3: interacting the created pelagic clustered island environment with the intelligent agents, testing and commissioning correctness and stability of the environment.

Step 4-2: designing a deep reinforcement learning method based on counterfactual baseline, configured to realize energy flow scheduling for the clustered islands and solving the energy management strategy.

Step 4-2-1: building a centralized training and decentralized execution deep reinforcement learning algorithm architecture based on Actor-Critic framework, wherein the architecture comprises a centralized Critic network and an Actor network of a number the same as the number of intelligent agents, wherein iteration rules of the algorithm are as following:

$${g}_{k} = {E}_{π} [ {\sum }_{a} {∇}_{{θ}_{k}} log {π}^{a} ( {u}^{a} \vert {τ}^{a} ) {A}^{a} ( s , u ) ] ;$$

Wherein gₖ is an iteration function at kth iteration, u^{a} stands for action of the intelligent agent a, τ^{a} stands for a trace sequence of the intelligent agent a, π^{a}(u^{a}|τ^{a}) stands for a strategy of the intelligent agent a in selecting the action u^{a} in the trace sequence τ^{a}, θₖ is a parameter at the kth iteration, s is a global system state, u stands for a united action of all the intelligent agents, and A^{a}(s,u) stands for an advantage function of the intelligent agent a.

Step 4-2-2: calculating an action strategy for each of the intelligent agents according to observation information of the intelligent agents in the islands and using the Actor network.

Step 4-2-3: calculating the advantage function based on the counterfactual baseline and using the Critic network, and reverting the corresponding results to the corresponding Actor network so as to address the problem of credit assignment.

Specifically, the idea of the counterfactual baseline is inspired by differentiated reward, the differentiated reward compares global reward r(s,u), and reward r(s,(u^{-a},c^{a})) obtained when replacing the action of the intelligent agent a with an action default and the definition is as following:

$${D}^{a} = r ( s , u ) - r ( s , ( {u}^{- a} , {c}^{a} ) ) ;$$

Wherein u^{-a} stands for the united action of all other intelligent agents (except the intelligent agent a), C^{a} is the action default for the intelligent agent a, D^{a} is the differentiated reward, where D^{a} is bigger than 0, the action that the intelligent agent a adopts is better than adopting the action default C^{a} where D^{a} is less than 0, the action that the intelligent agent a takes is worse than adopting the action default C^{a}.

However, with this method, usually a simulator is required to estimate r(s,(u^{-a}, c^{a}),as the differentiated reward of the intelligent agents requires individual counterfactual simulation, sampling is done repeatedly, which consumes a lot of time, and selection of the default action is not predictable. Therefore, a different way shall be configured, without requiring additional simulation computation and predication of the default action, instead, based on the current strategy, comparing average effects of the current action value function and the current strategy, which is called the advantage function, and the idea behind it is the same as the idea of differentiated reward while only computation ways are changed.

The computation method of the advantage function in an independent Actor-Critic structure:

$$A ( {τ}^{a} , {u}^{1} ) = Q ( {τ}^{a} , {u}^{a} ) - V ( {τ}^{a} ) ;$$

$$V ( {τ}^{a} ) = {\sum }_{{u}^{a}} {π}^{a} ( {u}^{a} \vert {τ}^{a} ) Q ( {τ}^{a} , {u}^{a} ) ;$$

Wherein Q(τ^{a},u^{a}) is the action value function of the intelligent agent a and V(τ^{a}) is the state value function of the intelligent agent a.

With reference to the computation method of the advantage function in the independent Actor-Critic structure, the way to calculate the advantage function in the present algorithm architecture: estimating the Q value of the united action u under condition of the global system state s using the centralized Critic network in the step 4-2-1, thereafter, comparing the Q value of the current action u^{a} with the counterfactual baseline of the marginalized u^{a}, maintaining actions of the other intelligent agents unchanged, and the advantage function A^{a}(s,u) is defined as following:

$${A}^{a} ( s , u ) = Q ( s , u ) - {\sum }_{{u}^{′ a}} {π}^{a} ( {u}^{′ a} \vert {τ}^{a} ) Q ( s , ( {u}^{- a} , {u}^{′ a} ) ) ;$$

in the equation, u′^{a} is an action of the intelligent agent a after marginalization.

Step 4-2-4: to calculate the counterfactual baseline more efficiently, taking actions of the other intelligent agents as a part of the network input, reserving output of counterfactual Q values of actions of a single intelligent agent, wherein Q value stands for the action value function of the intelligent agent.

Although in the step 4-2-3, evaluation using the Critic network has been employed to replace potential additional simulation, if the Critic network is a deep neural network, the evaluation is expensive, in order to output the counterfactual Q values of all the actions of all the intelligent agents, a number of the output nodes will amount to a size |u|ⁿ of the united action space, wherein U stands for all possible actions of an intelligent agent, n is a number of intelligent agents, apparently, this makes the training impractical. To calculate the counterfactual baseline more efficiently, during actual training, the actions u^{-a} of the other intelligent agents will be taken as a part of input of the Critic network, and during output, only the counterfactual Q values of the actions of the intelligent agent a will be reserved, and the efficient Critic network input and output are expressed as:

$$( {u}_{t}^{- a} , {s}_{t} , {o}_{t}^{a} , a , {u}_{t - 1} ) \to \{ Q ( {u}^{a} = 1 , {u}_{t}^{- a} , … ) , … , Q ( {u}^{a} = \vert U \vert , {u}_{t}^{- a} , … ) \} {\to }^{( {u}_{t}^{a} , {π}_{t}^{a} )} {A}_{t}^{a} ;$$

Wherein O^{a} is an observation of the intelligent agent a, a is a serial number of the intelligent agent, after obtaining the counterfactual Q values of actions of the intelligent agent a, the advantage function at the time Aₜ^{a} of the intelligent agent at such action can be obtained according to the strategy distribution πₜ^{a} of the intelligent agent a from the Actor network and the action uₜ^{a} at the current moment. With such network structure, the counterfactual advantage of each of the intelligent agent can be calculated efficiently by single forward pass via of the Actor network and the Critic network and the number of the output nodes is only |U| rather than |U|ⁿ.

In the present embodiment, energy flow scheduling for clustered islands is realized by multi-agent reinforcement learning methods and solving the energy management strategy so as to realize self-adaption to changes in loads of the islands with human settlements and guarantee operation stability and reliability of the power supply system in the clustered islands, compared with other algorithms, the method proposed in the present invention has integrated the baseline function on the basis of centralized training and decentralized execution, by usage of the baseline function, learning efficiency and stability of the algorithm is improved, energy flow scheduling and energy management of the pelagic clustered islands can be handled efficiently, and the problem that conventional optimization control methods encounter big restrictions when being used to deal with problems in conditions of no environment model or unknown global optimum.

In the description of the present invention, terms “an embodiment”, “some embodiments”, “examples”, “specific examples”, or “some examples” are intended to combine the specific features, structures, materials or characteristics of the embodiment or the example into at least one embodiment or example of the present invention. further, the specific features, structures, materials or characteristics can be combined in one or more embodiments or examples in appropriate ways. Further, where no conflict will occur, those skilled in the art can combine and mix different embodiments or examples and features in different embodiments or examples set forth in the present invention.

The logics and/or steps given or described in other ways in the flowchart diagram, for example, can be deemed to be a fixed sequence of executable instructions configured to realize the logical function and can be implemented in any computer readable medium for use in having the instructions to execute the system, device or apparatus (for example, system based on computers, systems comprising processors, or other system, apparatus or device that can be executed by instructions or can read instructions and execute the instructions) or for being combined to execute the system, device or apparatus.

In the foregoing embodiments, a detailed explanation is given to the present invention, in the present invention, specific examples are used to explain the principles and embodiments of the present invention, and the explanation in the embodiments is only intended to assist understanding the method and core idea of the present invention; in the meanwhile, for those of ordinary skill in the art, changes can be made to the embodiments and applications of the present invention based on the idea of the present invention, overall, the content of the present description shall not be construed as limitations on the present invention.

1. An energy flow scheduling method for pelagic clustered islands based on multi-agent reinforcement learning, comprising:
step 1: designing an energy flow transmission mode for clustered islands, wherein the mode is configured to describe energy flow transmission processes in between the clustered islands;
wherein, designing the energy flow transmission mode for the clustered islands comprises specifically the following steps:
step 1-1: forming a spatial distribution for at least one island with human settlements and a plurality of resource-rich islands according to unique geological positions of pelagic clustered islands;
step 1-2: building power generators including at least one wind power generation facility and at least one photovoltaic power generation facility for the plurality of resource-rich islands according to features of islands having rich renewable resources, and building a model for a renewable energy power generation facility for the clustered islands,
step 1-3: building an energy flow scheduling frame including at least one electric vessel based on natural geological isolation between the at least one island with the human settlements and the resource-rich islands and building an electric vessel operation model,
step 2: building an energy flow transmission model for the clustered islands based on the energy flow transmission mode for the clustered islands;
wherein building the energy flow transmission model for the clustered islands in the step 2, specifically comprises the following steps:
step 2-1: conducting pre-dispatch for an energy flow scheduling system for the clustered islands, predicting and scheduling power demands of m island(s) with the human settlements and power supply of n resource-rich islands;
Step 2-2: establishing an energy flow transmission mechanism according to pre-dispatch of the energy flow scheduling system for the pelagic clustered islands;
step 2-3: as a mobile energy storage tool, the at least one electric vessel charge and discharge in different times in the resource-rich islands and islands with human settlements to realize spatio-temporal transference of the energy flow in between islands, and an electric vessel charging and discharging model is defined as:
$${E}_{EV , t} = \{ \begin{matrix}{E}_{EV , t - 1} + {P}_{EV , t - 1} ζ Δ t & {P}_{EV , t - 1} < 0 \\ {E}_{EV , t - 1} - \frac{{P}_{EV , t - 1}}{ζ} Δ t & {P}_{EV , t - 1} \geq 0\end{matrix}$$
in foregoing equation, E_{V,t} and E_{V,t-1} stand for energy storage amounts of the at least one electric vessel at the time t and a time t−1, P_{EV,t-1} is a real-time power during charging and/or discharging of the at least one electric vessel at the time t−1, ξ stands for charge-discharge efficiency, and Δt stands for a temporal interval;
step 3: building an energy management model for an energy system of the clustered islands according to the energy flow transmission model for the clustered islands; comprising specifically:
step 3-1: designing an energy management object function for the resource-rich islands, comprising two parts: expenses for transporting energies with the at least one electric vessel and wind and light usage expenses of the resource-rich islands, aiming at satisfying loads of the islands with human settlements and reducing transportation expenses of the energy flow and waste of the renewable energies, and the object function Fᵣ is expressed as following:
$${F}_{r} = {\sum }_{t ∈ T} {\sum }_{i = 1}^{n} {\sum }_{{j = 1}^{}}^{m} {ξ}_{ij} {d}_{ij} {N}_{ij , t} {E}_{EV , t} + {\sum }_{t ∈ T} {\sum }_{i = 1}^{n} ψ ( {E}_{wind , i , t} + {E}_{pv , i , t} )$$
wherein, dᵢⱼ stands for a distance in between the ith resource-rich island and the jth island with human settlements, E_{wind,i,t} is a wind consumption amount at the ith resource-rich island at the time t, E_{pv,i,t} is a light consumption amount of the ith resource-rich island at the time t, ξᵢⱼ is a distance coefficient in between the ith resource-rich island and the ith island with human settlements, and ψ stand for a wind and light consumption penalty factor; N_{ij,t} stands for a number of at least one electric vessel sent to the jth island with human settlements from the ith resource-rich island at the time t;
step 3-2: designing an energy management result function for the islands with human settlements, comprising: cancelling expenses for controllable loads if necessary in order to ensure stability and reliability of operations of the power system of the clustered islands, and the result function Fₕ can be expressed as:
$${F}_{h} = {\sum }_{t ∈ T} {\sum }_{j = 1}^{n} λ {E}_{cut , j , t} ;$$
wherein E_{cut,j,t} stands for the cancelled controllable loads in the jth island with human settlements at the time t and is λ load cancelling penalty factor, and
step 4: realizing energy flow scheduling for the clustered islands by multi-agent reinforcement learning methods, and solving an energy management strategy.

2. The energy flow scheduling method for pelagic clustered islands based on multi-agent reinforcement learning according to claim 1,
wherein building a renewable energy power generation model for the clustered islands comprises:
$${P}_{w} = \frac{1}{2} {ρ}_{air} {A}_{w} {C}_{p} {v}^{3} ;$$
$${P}_{s} = η {A}_{s} G ;$$
wherein, P_{w} and Ps stand for output power of the at least one wind power generation facility and the at least one photovoltaic power generation facility, βₐᵢᵣ stands for air density, A_{w} stands for an efficient area of wind passing at least one wind turbine, Cₚ stands for a power coefficient of the at least one wind turbine of the at least one wind power generation facility, v stands for wind velocity, η stands for a power conversion efficiency of the at least one photovoltaic power generation facility, Aₛ stands for an area of at least one solar cell, and G stands for solar radiation strength;
wherein the electric vessel operation model comprises:
$${P}_{EV}^{sail} = {F}_{EV} {V}_{EV} cos θ ;$$
wherein, P_{EV}^{sail} stands for electric vessel navigation power, F_{EV} stands for thrust of the at least one electric vessel, V_{EV} stands for a navigation velocity of the at least one electric vessel, θ stands for an included angle between the thrust and the navigation velocity of the at least one electric vessel;
wherein, the thrust of the at least one electric vessel F_{EV}, an air friction Fₐᵢᵣ and ocean current force F_{cut} satisfy:
$${F}_{air}^{2} + {F}_{cur}^{2} - {F}_{EV}^{2} = 2 {F}_{air} {F}_{cur} cos γ ;$$
wherein, γ is an included angle between the air friction and the ocean current force; models of the air friction Fₐᵢᵣ and the ocean current force F_{cur} are respectively:
$${F}_{air} = \frac{9.807 {ρ}_{air} {C}_{w} {K}_{α} {A}_{ev} {V}_{rs}}{2} ;$$
$$\{ \begin{matrix}{F}_{xcur} = \frac{{ρ}_{water} {MV}_{crs}^{2} {C}_{xcur , β}}{2} \\ {F}_{ycur} = \frac{{ρ}_{water} {MV}_{crs}^{2} {C}_{ycur , β}}{2} \\ {F}_{cur} = \sqrt{{F}_{xcur}^{2} + {F}_{ycur}^{2}}\end{matrix} ;$$
wherein, C_{w} stands for a wind resistance coefficient where a wind angle is 0°, C_{xcur,β} and C_{ycur,β} stand for ocean current force coefficients where a relative angle of current is β, Kₐ stands for a wind influencing coefficient where the relative angle of current is a, Aₑᵥ stands for a projected area of a portion of the at least one electric vessel above a ship waterline on a cross section, Vᵣₛ stands for a relative wind speed of the at least one electric vessel, V_{crs} stands for a relative ocean current speed, M is a product of a length of the waterline and a draught, the length of the waterline stands for a projected length of the at least one electric vessel on a water surface, and the draught stands a depth of the at least one electric vessel in the water, β_{water} stands for seawater density, and F_{xcur} and F_{ycur} stand for sea current forces that the at least one electric vessel are subjected to on a horizontal direction and a vertical direction.

3. The energy flow scheduling method for pelagic clustered islands based on multi-agent reinforcement learning according to claim 1,
Wherein the resource-rich islands and the islands with the human settlements satisfy constraints:
$${\sum }_{i = 1}^{n} {E}_{i , t} \leq {E}_{j , t} j ∈ [ 1 , m ] , t ∈ T ;$$
in the equation, E_{i,t} stands for power supplied to an ith resource-rich island at a time t, E_{j,t} stands for a power demand for a jth island with human settlements at the time t, and T stands for total time duration;
wherein a transmission mechanism for energy flows in between the clustered islands comprises:
$$\{ \begin{matrix}{A}_{i , t} = {N}_{ij , t} \\ {S}_{j , t} = {\sum }_{i = 1}^{n} {N}_{ij , t}\end{matrix} i ∈ [ 1 , n ] , j ∈ [ 1 , m ] , t ∈ T$$
wherein, N_{ij,t} stands for a number of at least one electric vessel sent to the jth island with human settlements from the ith resource-rich island at the time t, A_{i,t} stands for a number of at least one electric vessel sent from the ith resource-rich island at the time t, S_{j,t} stands for a number of at least one electric vessel received by the jth island with human settlements at the time t,
further, to evaluate whether the at least one electric vessel charge or discharge fully is described by a state of charge SOC_{EV}, SOC_{EV}=1 stands for fully charged, SOC_{EV}=O stands for fully discharged, and definitions of the same are:
$${SOC}_{EV} = \frac{{E}_{sur}}{{E}_{total}} ;$$
$${SOC}_{EV , min} \leq {SOC}_{EV} \leq {SOC}_{EV , max} ;$$
wherein, Eₛᵤᵣ stands for remaining energy storage in the at least one electric vessel, Eₜₒₜₐₗ stands for total energy storage in the at least one electric vessel, and SOC_{EV,max} and SOC_{EV,min} stand for maximum and minimum statements of charge.

4. The energy flow scheduling method for pelagic clustered islands based on multi-agent reinforcement learning according to claim 3, wherein in the step 2-2, depending on pre-dispatching of a system and capacity Cap_{EV} of the at least one electric vessel, the system will decide whether each of the resource-rich islands shall send an electric vessel to the islands with human settlements and the number of the at least one electric vessel, and after energy scheduling, each of the islands with human settlements shall satisfy:
$${S}_{j , t} * {Cap}_{EV} \leq {E}_{j , t} .$$

5. (canceled)

6. (canceled)

7. The energy flow scheduling method for pelagic clustered islands based on multi-agent reinforcement learning according to claim 1, wherein in the step 4, realizing an energy flow scheduling for the clustered islands by a multi-agent reinforcement learning method and solving the energy management strategy comprising specifically:
step 4-1: establishing self-defined pelagic clustered island environments for multi-agent systems based on third-party libraries such as PettingZoo and extensions;
step 4-2: designing a deep reinforcement learning method based on counterfactual baseline, for energy flow scheduling for the clustered islands and solving the energy management strategy.

8. The energy flow scheduling method for pelagic clustered islands based on multi-agent reinforcement learning according to claim 7, wherein in the step 4-1, establishing the self-defined multi-agent pelagic clustered island environments comprising specifically the following steps:
step 4-1-1: defining self-defined environment class, realizing necessary methods, and the methods define interaction logics for the pelagic clustered island environment;
step 4-1-2: in a custom pelagic clustered island environment class, defining a state space S, an action space A and a reward mechanism R;
step 4-1-3: interacting the created pelagic clustered island environment with an intelligent agent, testing and commissioning correctness and stability of an environment.

9. The energy flow scheduling method for pelagic clustered islands based on multi-agent reinforcement learning according to claim 7, wherein the step 4-2 specifically comprises the following steps:
step 4-2-1: building a centralized training and decentralized execution deep reinforcement learning algorithm structure based on Actor-Critic frame, wherein an architecture thereof comprises a centralized Critic network and an Actor network with a same number of actors as intelligent agents;
step 4-2-2: calculating an action strategy for each of the intelligent agents based on observation information of each of an island intelligent agents and using the Actor network;
step 4-2-3: calculating a dominant function based on the counterfactual baseline and using the Critic network, and reverting the corresponding result to the corresponding Actor network, so as to address a credit assignment problem;
step 4-2-4: using actions U^{-a} of other intelligent agents as a part of an input of the Critic network to calculate the counterfactual baseline more efficiently, during outputting, reserving only counterfactual Q values of actions of a single intelligent agent a, and efficient Critic network input and output are expressed as:
$$( {u}_{t}^{- a} , {s}_{t} , {o}_{t}^{a} , a , {u}_{t - 1} ) \to \{ Q ( {u}^{a} = 1 , {u}_{t}^{- a} , … ) , … , Q ( {u}^{a} = \vert U \vert , {u}_{t}^{- a} , … ) \} {\to }^{( {u}_{t}^{a} , {π}_{t}^{a} )} {A}_{t}^{a}$$
wherein Q represents an action value function of the intelligent agent, O^{a} stands for observation of the intelligent agent a, a is a serial number of the intelligent agent, after obtaining the counterfactual Q value of the action of the intelligent agent a, obtaining the dominant function Aₜ^{a} of the intelligent agent at the time t of the action according to the strategy distribution πₜ^{a} obtained via the Actor network and the action uₜ^{a} at the current moment, sₜ stands for a status of the environment at the time t and uₜ₋₁ stands for actions of the intelligent agent at a time step t−1.

10. The energy flow scheduling method for pelagic clustered islands based on multi-agent reinforcement learning according to claim 7, wherein a method to calculate the dominant function in the step 4-2-3 is: estimating Q value of united action u in condition of a global state of the system using the centralized Critic network in the step 4-2-1, thereafter, comparing the Q value of the current action u^{a} with the counterfactual baseline of marginalized u^{a} and in the meanwhile, maintaining actions of the other intelligent agents unchanged, the dominant function A^{a} (s,u) is defined as following:
$${A}^{a} ( s , u ) = Q ( s , u ) - {\sum }_{{u}^{′ a}} {π}^{a} ( {u}^{′ a} \vert {τ}^{a} ) Q ( s , ( {u}^{- a} , {u}^{′ a} ) )$$
wherein u′^{a} stands for action after marginalization of the intelligent agent a, u^{-a} stands for united actions of all other intelligent agents without the intelligent body a, τ^{a} stands for a trace sequence of the intelligent agent a, π^{a} (u′^{a}|τ^{a}) stands for an action selection strategy of the intelligent agent a in the trace sequence τ^{a}, and Q (s,(u^{-a},u′^{a}) stands for the Q value when replacing the action of the intelligent agent a with the marginalized action.
